(19) United States
(12) Patent Application Publication
(10) Pub. No.: US 2017/0216959 A1
(43) Pub. Date: Aug. 3, 2017

(54) METHOD OF IMPACT WELDING REPAIR OF HOLLOW COMPONENTS

(71) Applicant: Siemens Energy, Inc., Orlando, FL (US)

(72) Inventor: Gerald J. Bruck, Titusville, FL (US)

(21) Appl. No.: 15/010,137

(22) Filed: Jan. 29, 2016

(51) Int. Cl. B23K 20/06; B23K 20/24; B23K 20/26; B23K 20/00

(52) U.S. Cl. CPC B23K 20/06; B23K 20/002; B23K 20/24; B23K 20/26; B23K 2203/05

(57) ABSTRACT

A method of impact welding a flyer to a hollow component is provided. The method includes providing the component made of a first material and including a cavity where a weld site is disposed on a first side of the component. An incompressible material is packed against a second side of the component opposite the first side facing the cavity. A flyer made of a second material is positioned onto the weld site. The flyer is then impact welded to the component. The incompressible material prevents the deformation of the component during the impact welding. A method of impact welding a cover plate to a component is provided as well as a support system for welding repair of hollow components.

### BACKGROUND

1. Field

The present application relates to gas turbines, and more particularly to a method of impact weld repair of hollow components. A support system for welding repair of components is also provided.

2. Description of the Related Art

Many cast gas turbine components, especially those along the hot gas path, are composed of high temperature materials as these materials can withstand an extremely hot and corrosive environment better than most other materials. However, current gas turbine components continue to get damaged from sustained exposure in the environment of the hot gas path and need either replacement or repair. These gas turbine components are not readily weld-repaired by processes that cause melting of the substrate, for example, arc welding processes and beam welding processes. Solidification and reheat cracking often result from such heat-dependent processes. Solid state welding provides an alternative to these processes such that these problems may be avoided. In solid state welding, the substrate is not melted; it produces coalescence at temperatures essentially below the melting point of the materials being joined.

Impact welding processes are solid state welding processes that produce a weld by a high velocity impact of the workpieces without a significant increase in the temperature of either workpiece. Examples of impact welding processes are magnetic pulse welding, explosion welding, vaporized foil actuator welding, and laser impact welding. Magnetic pulse welding uses magnetic forces to weld two workpieces together by accelerating one workpiece towards another workpiece. Explosion welding produces a weld by a high velocity impact of the workpieces as the result of a controlled detonation of explosives. Vaporized foil actuator welding is a process that rapidly vaporizes a consumable body generating a gas pressure. This gas pressure may accelerate a material at a high velocity which then collides with another material forming a weld. Laser impact welding joins two materials together using the energy of the laser to generate a pressure that may accelerate one material towards another at a high velocity creating a high impact weld.

Typically when explosion welding two components, a relatively thin clad layer, also known as a ‘flyer’, is welded using the impact from the controlled detonation to a relatively thick ‘backing’ plate. The flyer may be separated from the backing plate by a small gap. The explosive is placed on the flyer which may be contained in a frame. A detonator starts the process and the detonation progresses across an extent of the flyer. The pressures created from the detonation in the explosion welding process must be sustained by the ‘backing’ plate with the earth for support or using a supplemental support in order for a high impact weld to be formed.

US 2012/01213626 proposes to use explosion welding to form a gas turbine shroud by metallurgically applying a heat resistant cladding layer to a less heat resistant ribbed structure.

Impact welding is considered useful for joining of dissimilar metals and for the welding together of materials whose combination is not considered weldable by processes that melt and mix the substrates. Impact welding processes offer the possibility of welding gas turbine components comprising high temperature materials without the disadvantages of heat dependent fusion welding processes, as described above. However, welding of thin-walled components using high impact welding such as explosion welding has the disadvantage that the high pressure (in a typical range of 1.5 to 6.0 GPa) created by a high velocity impact may cause deformation of the thin walled portion of the component.

### SUMMARY

Briefly described, aspects of the present disclosure relate to a method of impact welding a flyer to a hollow component, a method of impact welding a cover plate to a component including a cavity, and a support system for welding repair of hollow components.

A method of impact welding a flyer to a hollow component is provided. The method includes providing the component comprising a first material and including a cavity where a weld site is disposed on a first side of the component. The first material is selected from the group consisting of superalloys, stainless steels, and high temperature nickel based alloys. An incompressible material is packed against a second side of the component opposite the first side facing the cavity. A flyer comprising a second is positioned onto the weld site. The flyer is then impact welded to the component. The incompressible material prevents the deformation of the component during the impact welding. The second material is selected from the group consisting of superalloys, stainless steels, and high temperature nickel based alloys.

A method of impact welding a cover plate to a component including a cavity is provided. The method includes providing a component comprising a first material selected from the group consisting of superalloys, stainless steels, and high temperature nickel based alloys and including a cavity. The cavity is filled with an incompressible material. A cover comprising a second material selected from the group consisting of superalloys, stainless steels, and high temperature nickel based alloys is positioned onto a weld site such that a surface of the cover plate abuts the incompressible material in the cavity. The cover plate is then impact welded to the component such that the cover plate closes the cavity. The incompressible material prevents the deformation of the cover plate.

A support system for welding repair of hollow components is provided. The support system includes a first component including a cavity, an incompressible material contained in the cavity, and a second material selected from the group consisting of superalloys, stainless steels, and high temperature nickel based alloys to be welded to the first component. The incompressible material prevents deformation of the first component or the second material during an impact welding procedure of the second material to the first component. A first material of the component is selected from the group consisting of superalloys, stainless steels and high temperature nickel based alloys.

### BRIEF DESCRIPTION OF THE DRAWINGS

FIG. 1 illustrates a first embodiment of a support system for the welding repair of hollow components,

FIG. 2 illustrates the progression of welding resulting from a detonation of the ignitable material as used in an explosion welding procedure,

FIG. 3 illustrates the resulting weld from the impact welding shown in FIG. 2,

FIG. 4 illustrates an embodiment of the weld after a machining,

FIG. 5 illustrates a support housing including a hollow fuel cavity,

FIG. 6 illustrates a second embodiment of a support system for the welding repair of hollow components,

FIG. 7 illustrates the progression of welding of the second embodiment resulting from a detonation of an ignitable material as used in an explosion welding procedure, and

FIG. 8 illustrates the welds that are formed as a result of the detonation of the impact welding procedure as shown in FIG. 7.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

After long exposures to the hot and corrosive environment of the hot gas path of a gas turbine, many cast components become damaged requiring them to either be scrapped and replaced or repaired. Fusion weld processes as discussed above are used with limited success. A method of welding hollow components using solid state welding as well as a support system for the welding repair of hollow components is provided.

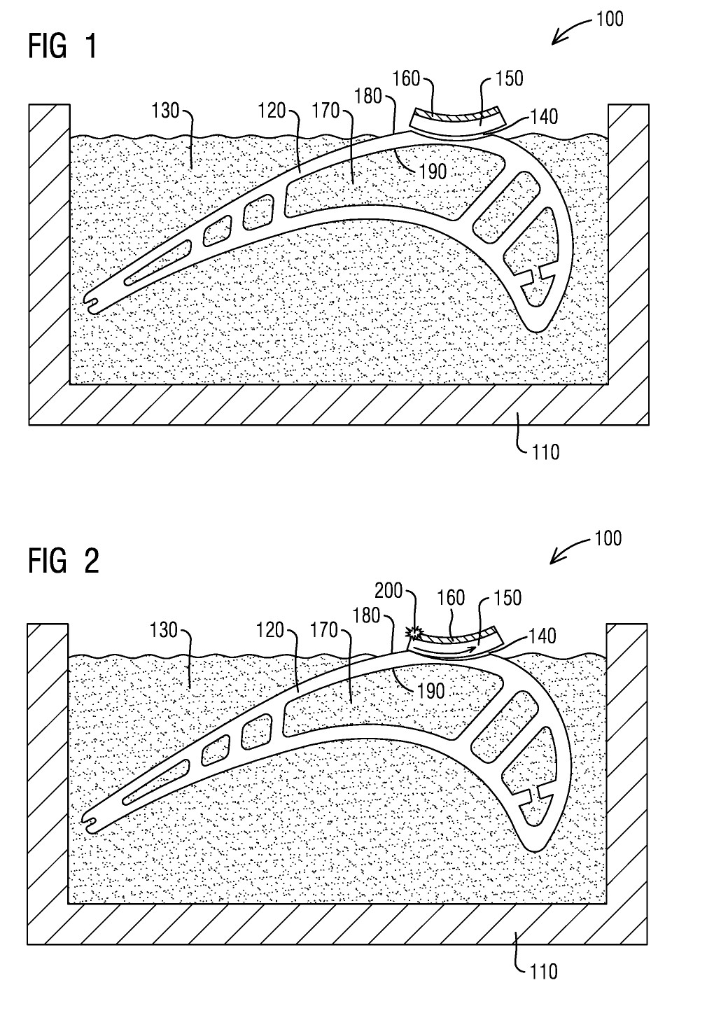

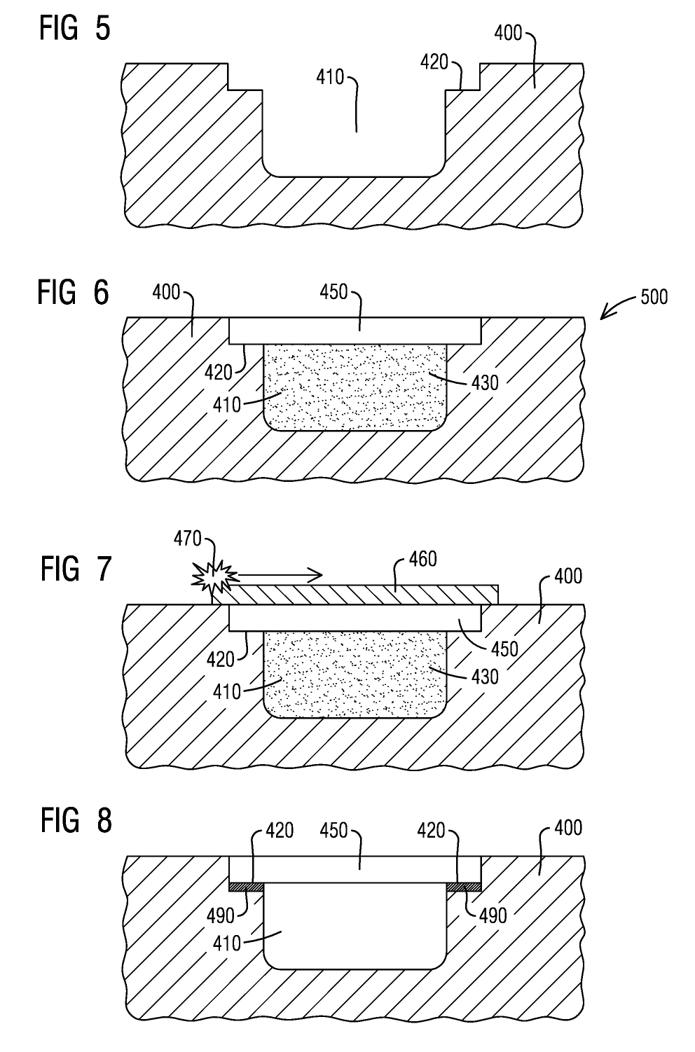

FIGS. 1 and 6 depict embodiments of a support system 100, 500 for the welding repair of a hollow component 120, 400. In the embodiment of FIG. 1, the hollow component is a hollow turbine blade 120. In the embodiment shown in FIG. 6, the hollow component is a support housing 400 containing a fuel cavity 410 as shown in FIG. 5. The hollow portion 170,410 may be packed with an incompressible material 130, 430.

In particular, FIG. 1 illustrates a cross sectional view of a hollow turbine blade 120 immersed in a bed of incompressible material 130. In this embodiment, a support container 110 is provided to contain the incompressible material 130. The support container 110 is filled with the incompressible material 130. A hollow turbine blade 120 comprising a material is partially submerged in the incompressible material 130 such that the incompressible material 130 fills the hollow portion, or cavity 170, of the hollow turbine blade 120. An outer portion of the hollow turbine blade 120 including a weld site 140 is not submerged in the incompressible material 130. An inserted material, or flyer, 150 may be placed onto the weld site 140 to be welded to the hollow turbine blade 120. The material of the hollow turbine blade 120 may be selected from the group consisting of superalloys, stainless steels, and high temperature nickel based alloys. The material of the flyer 150 may also be selected from the group consisting of superalloys, stainless steels, and high temperature nickel based alloys.

In order to weld the flyer 150 to the hollow turbine blade 120, an impact welding procedure may be used. In the embodiment shown, for example, an explosion welding procedure is used. However, one skilled in the art would understand that other forms of impact welding as described above may also be used. In the shown embodiment, an ignitable material 160 may be disposed on the outer surface of the flyer 150 such that it covers the flyer 150. Ignition of the ignitable material 160 creates a detonation that may start at a point on the outer surface of the flyer 150 and proceed from left to right in the two dimensional illustration. However, as only a cross section of the support system 100 is shown, it should also be noted that the detonation could also proceed into and out of the plane of FIG. 1.

During an impact welding procedure, the incompressible material 130 may be used to support the hollow turbine blade 120. As pressures in the range of 1.5 to 6.0 GPa are common during impact welding procedures, the incompressible material 130 would be capable of sustaining pressures in this range during the impact welding procedure. A typical time frame for the length of an impact weld procedure may be 3 to 25 microseconds.

The incompressible material 130 may include a variety of materials that effectively prevent the deformation of the hollow component 120, 400 during an impact welding procedure. It would be desirable for the incompressible material 130 not to negatively react with the hollow component 120, 400. It would be advantageous for the incompressible material 130 to be readily drained out of the hollow component 120, 400 after the impact welding procedure. Some examples of incompressible materials 130 may be water, sand, dry ice, sodium potassium (NaK), oil, polymer, and wax.

The configuration of the flyer 150 with respect to the hollow component 120 may be parallel, as shown in FIG. 1, or at a modest angle with respect to each other. The modest angle may be in the range of 5 to 20 degrees. Using a configuration including a modest angle may be instrumental in controlling the direction of the weld progression, however, it is widely recognized to be typically limited to weld lengths less than 20 times the backing plate thickness. These typical weld lengths would accommodate most hollow turbine blade and vane weld repairs.

FIG. 6 depicts a second embodiment of a support system 500 for the welding repair of components. In particular, FIG. 6 illustrates a cross sectional view of a fuel cavity 410 of the support housing 400 containing incompressible material 430. A cover plate 450 is to be impact welded onto a shelf 420 in the fuel cavity 410. The cover plate 450 in this embodiment takes on the functionality of the flyer which may be placed on the shelf 420, or weld site, of the fuel cavity 410. The cover plate 450 may be in a range greater than 8mm thick. The material of the cover plate 450 may be a superalloy material or more typically a wrought stainless or high temperature nickel base alloy. During the impact welding procedure, the deformation of the cover plate 450 is prevented by the support of the incompressible material 430.

Similarly to the embodiment of FIG. 1, an explosion welding procedure is shown as the impact welding procedure in the embodiment of FIG. 6. However, one skilled in the art would understand that other forms of impact welding as described above may also be used. In the shown embodiment, an ignitable material 460 is disposed on the outer surface of the cover plate 450, or flyer, such that it covers the flyer. Ignition of the ignitable material 460 creates a detonation that may start at a point and proceed from left to right, or right to left, in the two dimensional illustration. However, as only a cross section of the support system is shown, it should also be noted that the detonation could also proceed into and out of the plane of the figure.

Referring to FIGS. 1-4, a method of impact welding a flyer 150 onto a hollow component 120 is also provided. In an embodiment, a hollow component 120 comprising a first material is provided including a weld site 140 on a first side 180 of the hollow component 120. The hollow component includes a cavity 170. An incompressible material 130 is packed against a second side 190 of the hollow component 120 opposite the first side 180 and facing the cavity 170. A flyer 150 comprising a second material may be positioned onto a weld site 140 on a first side 180 of the hollow component 120. Impact welding may be used to form a weld between the flyer 150 and the hollow component 120. The incompressible material 130 prevents the deformation of the hollow component 120 during the impact welding.

In the embodiment illustrated in FIGS. 1-4, a support container 110 is shown filled with the incompressible material 130. A hollow turbine blade 120 is partially submerged in the incompressible material 130 such that a portion of the hollow turbine blade 120 including the weld site 140 is not submerged. A flyer 150 comprising a second material is positioned onto the weld site 140. The second material may include a superalloy material or other materials suitable to be welded to the first superalloy material. An impact welding procedure is used to impact weld the flyer 150 to the hollow turbine blade 120 such that the incompressible material 130 prevents deformation of the hollow turbine blade 120 during the impact welding.

Prior to the positioning, the weld site 140 may be excavated such that damaged material is removed. FIG. 1 shows an excavated weld site 140 in a hollow turbine blade 120 onto which the flyer 150 may be positioned.

In an embodiment, the flyer 150, 450 may be positioned parallel to the hollow component 120, 400. In another embodiment, the flyer 150, 450 may be positioned at a slight angle to the hollow component 120, 400. The slight angle may be in a range of 5 to 20 degrees. Such a slight angle may be used to control the direction of the weld progression during impact welding.

In the shown embodiment in FIG. 1, the hollow component 120 includes a thin unsupported member that includes the weld site 140. Packing the cavity 170 may include filling the cavity 170 with the incompressible material to provide support to the thin unsupported member. The thin unsupported member may include a thickness in a range between 0.2-10 mm.

FIG. 2 illustrates the progression of welding, as shown by the arrow, resulting from a detonation 200 of the ignitable material 160 as used in an explosion welding procedure. The detonation 200 may begin at a point on a surface of the flyer 150 and proceed across the flyer 150. The force created by the detonation 200 onto the flyer 150 will accelerate the flyer 150 towards the hollow turbine blade 120 creating a weld of the flyer 150 to the hollow turbine blade 120. The length of the detonation 200 may last for a time period of 3 to 25 microseconds. An explosion welding procedure is illustrated in FIG. 2, however, the weld may be accomplished using other impact welding procedures such as magnetic pulse welding, vaporized foil actuator welding, and laser impact welding.

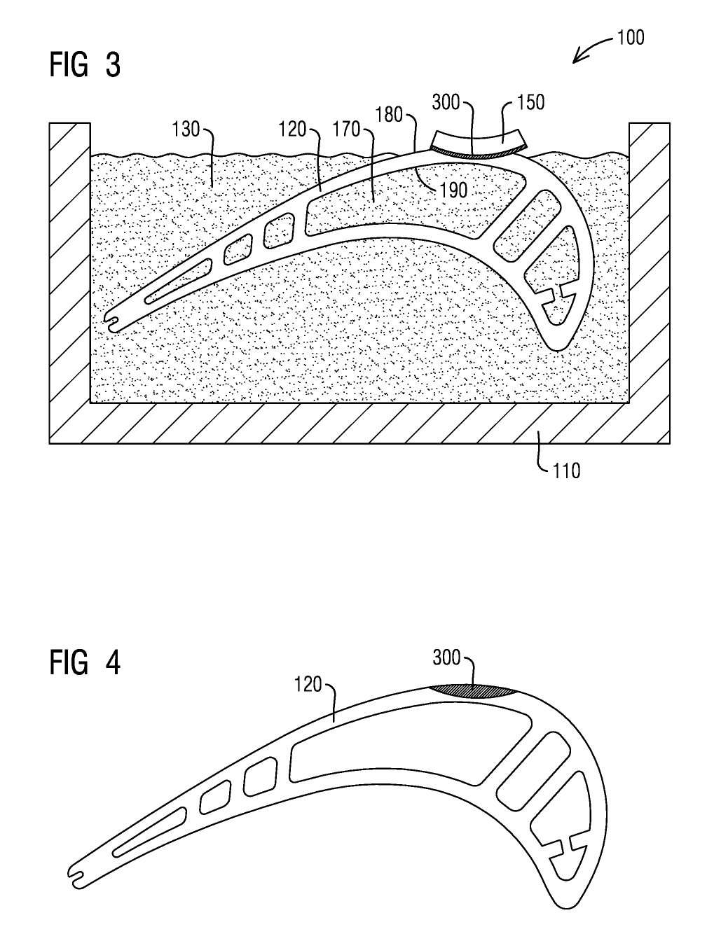

FIG. 3 illustrates the resulting weld 300 from the impact welding shown in FIG. 2. The incompressible material 130 prevented the deformation of the thin unsupported member, specifically the portion of the thin unsupported member including the weld 300. An outer contour of the resulting weld material comprising the second material in the illustrated embodiment does not conform to a desired contour of the hollow turbine blade 120.

After the impact welding, the welded second material may be machined in order for the outer contour of the second material to conform to the desired contour of the hollow turbine blade 120. An embodiment of the weld 300 after a machining is illustrated in FIG. 4. An outer surface of the second material of the weld 300 includes the desired contour of the hollow turbine blade.

Referring to FIGS. 5-8, an embodiment of a method of impact welding a cover plate to a component including a cavity is illustrated. FIG. 5 illustrates a component 400 including a cavity 410. For example, the component may be a support housing 400 including a fuel cavity 410. In the shown embodiment, the support housing 400 includes a shelf 420.

FIG. 6 illustrates the support housing 400 including a cover plate 450 positioned on the shelf 420 of the support housing 400. The cavity 410 may be filled with an incompressible material 430 such that the incompressible material 430 abuts a surface of the cover plate 450.

FIG. 7 illustrates the progression of the welding, as shown by the arrow, resulting from a detonation of an ignitable material 460 as used in an explosion welding procedure. The ignitable material 460 may be positioned on top of the cover plate 450. Igniting the ignitable material 460 initiates a detonation 470. The detonation 470 may begin at a point on a surface of the cover plate 450 and proceed across the cover plate 450. The force created by the detonation 470 onto the cover plate 450 will accelerate the cover plate 450 towards the shelf 420 on the support housing 400 creating a weld of the cover plate to the support housing. The length of the detonation 470 may last for a time period of 3 to 25 microseconds. An explosion welding process is illustrated in FIG. 7, however, the weld may be accomplished using other impact welding processes such as magnetic pulse welding, vaporized foil actuator welding and laser impact welding.

FIG. 8 illustrates the welds 490 that are formed as a result of the detonation of the impact welding procedure. The welds 490 extend between the cover plate 450 and the shelf 420. It is notable that the vertical legs of the shelf are not shown welded in this illustration. There may be no need to make the vertical welds as long as the horizontal welds, as shown, are leak tight. Alternately, the shelf may be a simple bevel or radius rather than a step.

The detonation 470 may begin at a single point on the surface at the periphery of the cover plate 450 and proceed across the surface as shown in FIG. 7. However, other embodiments are also possible. For example, the detonation may start at multiple points on the surface of the cover plate, or begin in the middle on the surface of the cover plate and proceed toward the periphery.

In the embodiment shown in FIG. 8, the incompressible material 430 has been removed or drained from the fuel cavity 410 after the impact welding. This may be accomplished in various ways depending on the incompressible material 430 chosen. For example, water may be easily drained out of some configurations while dry ice may be sublimated.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A method of impact welding a flyer to a hollow component, comprising:
providing the component comprising a first material selected from the group consisting of superalloys, stainless steels, and high temperature nickel based alloys, and including a cavity wherein a weld site is disposed on a first side of the component;
packing an incompressible material against a second side of the component, the second side is opposite the first side and facing the cavity;
positioning a flyer comprising a second material onto the weld site; and
impact welding the flyer to the component,
wherein the second material is selected from the group consisting of superalloys, stainless steels, and high temperature nickel based alloys,
wherein the incompressible material prevents deformation of the component during the impact welding.

2. The method as claimed in claim 1, comprising preparing the weld site by excavating damaged material.

3. The method as claimed in claim 1, comprising machining the flyer after the impact welding in order for an outer contour of the second material to conform to a desired contour of the component.

4. The method as claimed in claim 1, wherein the impact welding procedure is selected from the group consisting of explosion welding, magnetic pulse welding, vaporized foil actuator welding, and laser impact welding.

5. The method as claimed in claim 1, wherein the component includes a thin unsupported member, the thin unsupported member including the weld site.

6. The method as claimed in claim 5, wherein the cavity of the component is filled with the incompressible material.

7. The method as claimed in claim 6, wherein the thickness of the thin unsupported member is in a range between 0.2-10 mm.

8. The method as claimed in claim 1, wherein the incompressible material is selected from the group consisting of water, sand, dry ice, oil, polymer, wax, and sodium potassium alloy (NaK).

9. The method as claimed in claim 4, wherein the impact welding procedure is explosion welding.

10. The method as claimed in claim 9, wherein a detonation begins at a point on the surface of the flyer and proceeds across the flyer.

11. The method as claimed in claim 10, wherein the detonation lasts for a time period of 3 to 25 microseconds.

12. The method as claimed in claim 1, wherein the component and the flyer are positioned parallel to one another.

13. The method as claimed in claim 1, wherein the component and the flyer are positioned at an angle with respect to one another in the range of 5 to 20 degrees.

14. A method of impact welding a cover plate to a component including a cavity, comprising:
providing the component comprising a first material selected from the group consisting of superalloys, stainless steels, and high temperature nickel based alloys, the component including a cavity;
filling the cavity with an incompressible material;
positioning a cover plate comprising a second material selected from the group consisting of superalloys, stainless steels and high temperature nickel based alloys onto a weld site such that a surface of the cover plate abuts the incompressible material in the cavity; and
impact welding the cover plate to the component such that the cover plate closes the cavity,
wherein the incompressible material prevents deformation of the cover plate.

15. The method as claimed in claim 14, comprising removing the incompressible material after the impact welding.

16. The method as claimed in claim 14, wherein the impact welding procedure is selected from the group consisting of explosion welding, magnetic pulse welding, vaporized foil actuator welding, and laser impact welding.

17. The method as claimed in claim 16, wherein the impact welding is explosion welding.

18. The method as claimed in claim 17, wherein a detonation begins at a point on the cover plate and proceeds across the cover plate.

19. A support system for welding repair of hollow components, comprising:
a component including a cavity;
an incompressible material contained in the cavity;
a second material selected from the group consisting of superalloys, stainless steels and high temperature nickel based alloys to be welded to the component,
wherein the incompressible material prevents deformation of the component or the second material during an impact welding procedure of the second material to the component,
wherein a first material of the component is selected from the group consisting of superalloys, stainless steels and high temperature nickel based alloys.

20. The support system as claimed in claim 19, wherein a material of the component is the same as the second material.
